(19) United States
(12) Patent Application Publication
(10) Pub. No.: US 2026/0182783 A1
(43) Pub. Date: Jul. 2, 2026

(54) Portable Blender and Related Methods

(71) Applicant: Terronie Whittick, Suwanee, GA (US)

(72) Inventor: Terronie Whittick, Suwanee, GA (US)

(21) Appl. No.: 19/001,648

(22) Filed: Dec. 26, 2024

(51) Int. Cl. A47J 43/046; A47J 43/08

(52) U.S. Cl. CPC A47J 43/046; A47J 43/085

(57) ABSTRACT

A portable blending device includes a chamber with a blade for blending material, a charging port, a power control, a power source, and multiple attachment points. The device is compact with specific dimensions. The chamber and blade are positioned in the lower portion, and the charging port is a USB-C port located at the bottom. The power control is a button at the top, the port is also along the top portion, and the power source is a battery. The attachment points include at least two hooks on one side. The device measures approximately 1.2 inches in length and width, and 3.5 inches in height.

### TECHNICAL FIELD

Embodiments of the invention relate to a compact and portable blender designed for user convenience and ease of use.

### BACKGROUND

In recent years, the demand for portable and convenient kitchen appliances has surged, driven by the fast-paced lifestyle of modern consumers. Among these appliances, portable blenders have gained significant popularity due to their ability to provide quick and easy solutions for making smoothies, shakes, and other blended beverages on the go. Traditional blenders, while effective, are often bulky and require a constant power source, making them less suitable for individuals who need a more mobile solution. The need for compact, battery-operated blenders that can be easily carried in a bag and used anywhere has led to various innovations in the design and functionality of these devices.

One of the primary challenges in designing portable blenders is ensuring that they are both powerful enough to blend a variety of ingredients and compact enough to be truly portable. Additionally, the convenience of charging and ease of use are critical factors that influence consumer preference. USB-C ports have become a standard for charging a wide range of electronic devices due to their fast charging capabilities and universal compatibility. Incorporating such features into portable blenders can significantly enhance their usability and appeal. Furthermore, the inclusion of attachment hooks can provide added convenience for users who wish to secure the blender to a bag or other items during transport, addressing the need for both functionality and portability in one compact device.

### SUMMARY

In accordance with embodiments, a portable blending device is provided. The portable blending device comprises a chamber positioned within the device, a blade within the chamber configured to blend material inserted into the chamber, a charging port, a power control, a power source, and multiple attachment points. The device is designed to be compact with specific dimensions.

In accordance with yet other embodiments, a method of using a portable blending device is provided. The method comprises inserting material into a chamber within the device, activating a power control to blend the material using a blade within the chamber, charging the device via a charging port, and attaching the device to an external object using multiple attachment points.

In accordance with yet further embodiments, the method further comprises blending the material inserted into the chamber to a desired consistency using the blade within the chamber.

### BRIEF DESCRIPTION OF THE DRAWINGS

FIG. 1 illustrates a perspective view of the portable blending device, in accordance with at least one embodiment.

FIG. 2 illustrates a side cross-sectional view of the portable blending device to show how the blade and battery are incorporated, in accordance with at least one embodiment.

FIG. 3 illustrates a top sectional view of the portable blending device to show a detailed view of the blade.

FIG. 4 illustrates a top view of the portable blending device, in accordance with at least one embodiment.

FIG. 5 illustrates, in a flowchart, operations and features of a portable blending device.

### DETAILED DESCRIPTION

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Materials described or referenced herein will sometimes be described in singular form for clarity. However, it should be appreciated that particular embodiments may include multiple instantiations of a material unless noted otherwise. Surfaces in some embodiments can be understood as representing segments or portions of those embodiments. Alternate implementations are included within the scope of embodiments of the present invention would be understood by those having ordinary skill in the art.

Headings of sections provided in this patent application and the title of this patent application are for convenience only and are not to be taken as limiting the disclosure in any way. A description of an embodiment with several components in connection with each other does not imply that all such components are required.

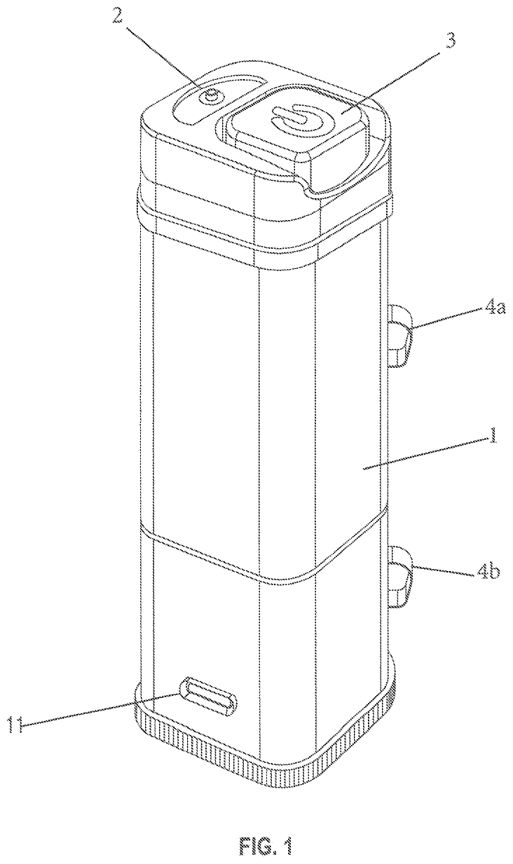

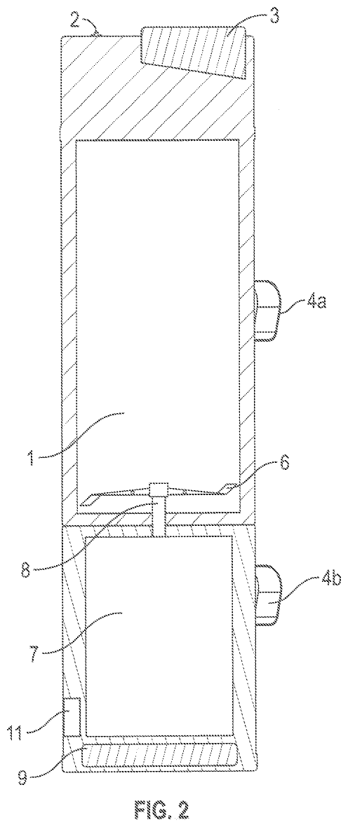

In different embodiments, various techniques may be employed to provide a portable blending device with components to blend materials efficiently while being compact and easy to use. Turning now to FIG. 1 depicts a perspective view of the portable blending device, in accordance with at least one embodiment. The portable blending device comprises a chamber 1 positioned within the device, which serves as the primary container for the material to be blended. The chamber 1 is positioned along a lower portion of the portable blending device to optimize blending performance. Within the chamber 1, a blade (shown in FIG. 2) is positioned along its lower portion, configured to blend the material inserted into the chamber to a desired consistency. This positioning ensures effective blending by allowing the blade to interact thoroughly with the material.

The portable blending device also includes a charging port 11, specifically a USB-C port, positioned along the bottom portion of the device. This placement is intended for user convenience, allowing easy access for charging the device. The USB-C port 11 is compatible with modern charging standards, ensuring that the device can be charged efficiently and universally. It will be appreciated that the USB-C port 11 is compatible with modern charging standards, ensuring that the portable blending device can be charged using widely available USB-C chargers. This compatibility is crucial for maintaining the portability and ease of use of the device, as users can charge it with common chargers they may already own. Furthermore, the USB-C port 11 design ensures that the portable blending device can be charged using a variety of compatible chargers, including those used for smartphones and other portable electronics. In summary, the USB-C port's position on the top portion of the portable blending device exemplifies a thoughtful design choice aimed at enhancing user convenience, ensuring compatibility with modern charging standards, and maintaining the device's durability. This compatibility is crucial for maintaining the portability and ease of use of the blending device, as users can charge it with readily available chargers.

Additionally, the device features a power control in the form of a power button 3, positioned along the top portion of the portable blending device. In the event that a user desires to disperse material, a port 2 along the top portion of the apparatus is used to distribute material from the chamber 1. This design choice facilitates easy operation, enabling users to activate the blending function with minimal effort. The power source for the device is a battery (shown in FIG. 2), which is included within the portable blending device to ensure portability and ease of use without the need for constant connection to a power outlet.

To enhance the portability and usability of the device, multiple attachment points are included, comprising at least two attachment hooks (4a, 4b) positioned along one side of the portable blending device. These hooks allow the device to be securely attached to external objects, making it convenient for users to carry and use the blender in various settings. In a non-limiting example, the attachment hooks (4a, 4b) may be made from materials such as stainless steel or reinforced plastic to ensure longevity and resistance to wear and tear. The design of the hooks may also include features such as a locking mechanism or a quick-release button to enhance the security and ease of use. These features ensure that the portable blending device remains securely attached to the external object during transport, preventing accidental drops or detachment.

The portable blending device is designed with specific dimensions, measuring approximately 1.2 inches in length, 1.2 inches in width, and 3.5 inches in height. These compact dimensions ensure that the device is easy to handle, store, and transport, making it an ideal solution for users who require a portable and efficient blending device.

In different embodiments, various techniques may be employed to specify the position of the chamber within the portable blending device for optimal blending performance. The positioning of the chamber 1 is advantageous as it allows for a more stable base and efficient blending of materials inserted into the chamber 1. The chamber's lower placement can facilitate the gravitational pull of the materials towards the blade 6, ensuring thorough blending.

The chamber's position is crucial for the overall functionality of the portable blending device. It works in conjunction with the blade 6, which is also positioned along a lower portion of the chamber. This alignment ensures that the materials are effectively blended to a desired consistency. The blade's lower placement within the chamber allows it to interact directly with the materials as they settle at the bottom, providing a more consistent and efficient blending process.

In at least one embodiment, by placing the chamber 1 at the lower portion, the design can maintain a balanced and ergonomic structure, making it easier for users to handle and operate the device. This design consideration aligns with the overall goal of creating a portable blending device that is both efficient and user-friendly. The chamber's positioning is a strategic design choice that enhances blending performance, ensures efficient material processing, and contributes to the device's compact and portable nature. This embodiment exemplifies how thoughtful design can optimize the functionality and user experience of a portable blending device.

Turning now to FIG. 2, in different embodiments, various techniques may be employed to specify the position and functionality of the blade 6 within the portable blending device. The blade's configuration is such that it can blend the material to a desired consistency, which is crucial for achieving the intended results of the blending process. The chamber 1, which houses the blade 6, is designed to accommodate the material and facilitate its interaction with the blade 6. Further, the positioning of the chamber 1 further contributes to the device's overall stability during operation. The portable blending device includes a power control, which in this embodiment is a power button 3. The power button 3 is positioned along the top portion of the portable blending device for user convenience, allowing easy access and operation. This placement ensures that the user can quickly activate the blending process without any hassle.

Additionally, the depiction shows a port 2 positioned along the top portion of the device for distributing material from chamber 1. The power source of the portable blending device is a battery 9, which provides the necessary power for the blending operation. The inclusion of a battery 9 as the power source ensures that the device remains portable and can be used in various locations without the need for a constant power supply. The two attachment hooks (4a, 4b) are positioned along one side of the portable blending device as depicted. The attachment hooks (4a, 4b) are designed to securely attach the portable blending device to external objects, providing users with the flexibility to carry or store the device conveniently. The attachment hooks (4b, 4b) may be used to hang the device on a backpack, belt, or any other suitable external object, ensuring that the device is always within reach and ready for use. In a non-limiting example, the portable blending device's dimensions are approximately 1.2 inches in length, 1.2 inches in width, and 3.5 inches in height, make the device easy to handle and store, further enhancing its portability and convenience for the user. The design of the device ensures that the device remains user-friendly and practical for everyday use. The integration of a USB-C port also aligns with current technological trends, providing a future-proof solution for the portable blending device's charging needs.

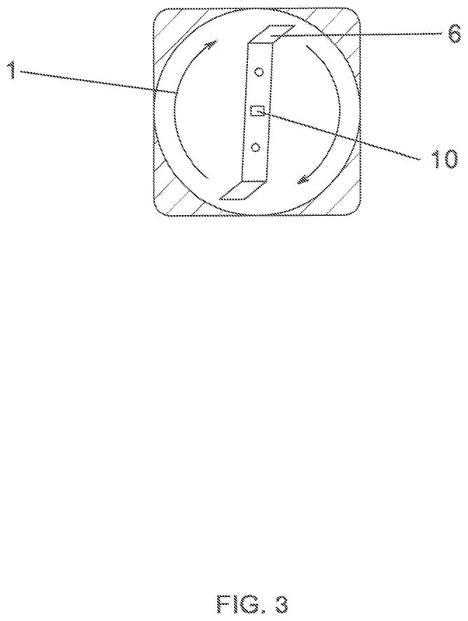

Turning now to FIG. 3, as depicted illustrates a top sectional view of the portable blending device. The blade 6 is shown as a top view to demonstrates how the blade is positioned within the chamber 1. The illustration further shows a protruding rectangular shaft 10 for insertion into the blade 6 via a mounting aperture. The rectangular shaft 10 is critical for rotating the blade 6 in that once the shaft is removably inserted the shaft will rotate once powered on and in turn rotates the blade 6. The illustration also shows a top view of the motor 7 that causes rotation in conjunction with adjoining parts such as the rectangular shaft 10 and blade 6. The mounting aperture is positioned along a longitudinal axis of the blade that passes through the blade 6 in an uninterrupted fashion to couple with the rectangular shaft 10. The rectangular shaft 10 is located at distal end of a secondary shaft 8 that extends from the motor 7. The chamber 1, which houses the blade 6, is positioned within the portable blending device to facilitate optimal blending performance. The blade's positioning along the lower portion of the chamber further enhances its blending efficiency.

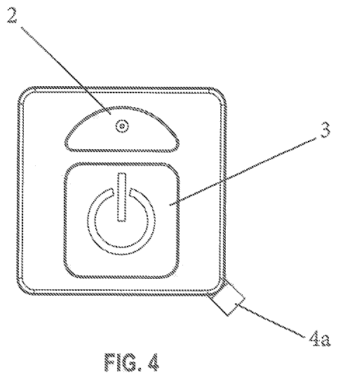

Furthermore, the blade 6 is configured to blend material inserted into the chamber, ensuring that the material reaches the desired consistency. The length, width, and height are optimized to provide a balance between a compact form factor and the inclusion of all necessary components for efficient blending. This design ensures that users can easily carry the device and use it in various settings, whether at home, in the office, or on the go. The compact size also makes the device suitable for travel, allowing users to blend their favorite ingredients wherever they are. Referring to FIG. 4, as depicted is a top view of the portable blending device, in accordance with at least one embodiment. Various techniques may be employed to specify the type of power control used in the portable blending device for easy operation. The positioning of the power button 3 is intended to provide user convenience, allowing for easy access and operation of the blending device. The power button 3, when pressed, activates the blending mechanism within the chamber 1, enabling the blade 6 to blend the material inserted into the chamber 1 to a desired consistency. The illustration also shows an attachment hook (4a) along the side of the apparatus. Additionally, the placement of the port 2 along the top portion of the device may prevent potential issues related to liquid ingress or damage during blending operations, as it is positioned away from the chamber and blade. This strategic placement helps in maintaining the device's durability and longevity. This embodiment highlights the importance of considering both functionality and user experience in the design of portable electronic devices.

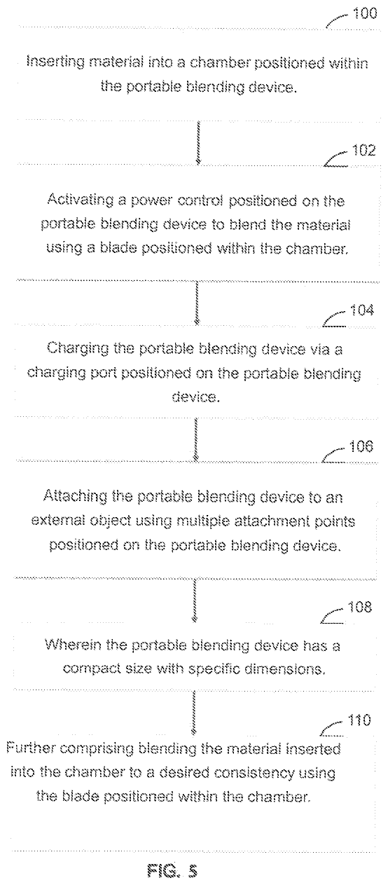

Turning now to FIG. 5, in step 100, the process begins with inserting material into a chamber positioned within the portable blending device. The chamber, being a component of the portable blending device, is designed to hold the material that will be blended. The material, which can be any substance intended for blending, is placed into this chamber. The portable blending device, as described, is a compact apparatus with specific dimensions, making it convenient for portability and use in various settings.

The chamber's positioning along the lower portion of the device is significant as it aligns with the design of the blade, which is also positioned within the chamber. This configuration ensures that the material is effectively blended when the device is activated. The insertion of the material into the chamber is a straightforward process, facilitated by the design of the portable blending device, which is user-friendly and efficient.

The portable blending device includes several components such as a USB-C port, a power button, a battery 9, and attachment hooks. These components work together to provide a seamless blending experience. The USB-C port 11 allows for easy charging, the power button 3 enables the user to activate the device, the battery 9 provides the necessary power, and the attachment hooks offer versatility in how the device can be used or stored.

Overall, step 100 provide a clear and detailed explanation of how the material is inserted into the chamber of the portable blending device, setting the stage for the subsequent steps that involve blending the material to a desired consistency.

In step 102, the process involves activating a power control positioned on the portable blending device to blend the material using a blade positioned within the chamber. This step further provides that a user pressing a power button positioned along a top portion of the portable blending device to activate the power control.

The entities associated with this step include the power control, portable blending device, material, blade, and chamber. The power control is embodied as a power button, which is a component for initiating the blending process. The portable blending device houses all these components and is designed to be compact and portable. The material refers to the substance that the user intends to blend, which is placed inside the chamber. The blade, positioned within the chamber, is responsible for blending the material once the power control is activated.

The actions associated with these entities are as follows:
The power control (power button) is pressed to activate the blending mechanism.
The portable blending device serves as the housing for all components and ensures the device's portability and usability.
The material is inserted into the chamber and is the target of the blending process.
The blade, upon activation by the power control, blends the material within the chamber.

The portable blender includes a chamber with a blade located along the lower portion of the chamber for blending material that is inserted by the user. The portable blender also includes a USB-C port 11 and a power button 3 along the top portion of the portable blender. The device measures 1.2 inches in length, 1.2 inches in width, and 3.5 inches in height, and includes a battery 9 and at least two attachment hooks along one side of the apparatus.

The logical flow of actions begins with the user pressing the power button, which is positioned along the top portion of the portable blending device. This action activates the power control, which in turn powers the blade positioned within the chamber. The blade then blends the material inserted into the chamber to the desired consistency. This sequence of actions ensures that the portable blending device operates efficiently and effectively to blend the material as intended.

In summary, step 102 detail the activation of the blending process in the portable blending device by pressing the power button, which activates the power control and subsequently the blade to blend the material within the chamber. This process is integral to the functionality of the portable blending device, ensuring that the user can blend materials conveniently and efficiently.

In step 104, the process involves charging the portable blending device via a charging port positioned on the portable blending device.

The battery 9 serves as the power source for the device, enabling its portability and functionality without the need for a constant external power supply. The inclusion of a battery 9 is crucial for maintaining the compact and portable nature of the blending device, allowing users to blend materials on the go.

This step further specifies that the charging of the portable blending device is accomplished via a USB-C port positioned along the top portion of the device. The USB-C port is a modern and versatile charging interface that supports fast charging and is widely compatible with various charging adapters and power sources. Positioning the USB-C port along the top portion of the device ensures easy access for users when connecting the charging cable, enhancing the user experience.

The combination of these steps illustrates a well-thought-out design that prioritizes user convenience and device efficiency. The battery 9 ensures that the device remains operational without being tethered to a power outlet, while the USB-C port provides a reliable and efficient means of recharging the battery 9. This design choice aligns with the compact and portable nature of the blending device, making it an ideal solution for users who require a convenient and efficient blending tool that can be easily recharged and used in various settings.

In step 106, the process involves attaching the portable blending device to an external object using multiple attachment points positioned on the portable blending device. This step further specifies that the attachment is achieved using at least two attachment hooks positioned along one side of the portable blending device.

The portable blending device includes multiple attachment points that facilitate its attachment to various external objects. These attachment points are exemplified by at least two attachment hooks, which are strategically positioned along one side of the device. The attachment hooks are designed to provide a secure and stable connection to external objects, ensuring that the portable blending device remains firmly in place during use or transport.

The attachment process begins by aligning the attachment hooks with corresponding points on the external object. Once aligned, the hooks are engaged to secure the portable blending device. This mechanism allows for easy and quick attachment and detachment, enhancing the portability and convenience of the device.

The inclusion of multiple attachment points and hooks not only adds to the versatility of the portable blending device but also ensures that it can be used in various settings and attached to different types of objects, such as bags, belts, or other personal items. This feature is particularly beneficial for users who need to carry the device while on the go, ensuring that it is always within reach and ready for use.

Overall, the attachment mechanism described in step 106 highlights the thoughtful design and functionality of the portable blending device, making it a practical and user-friendly tool for blending needs in various environments.

In step 108, the portable blending device is described as having a compact size with specific dimensions. The entities associated with this step include the portable blending device and specific dimensions. The actions associated with these entities involve defining the compact size and specifying the exact measurements of the device.

The portable blending device is designed to be compact, making it highly portable and convenient for users. The specific dimensions ensure that the device can easily fit into small spaces, such as a bag or a pocket, without compromising its functionality. The compact size is a feature that enhances the device's portability and usability, making it an ideal choice for users who need a blending solution on the go.

In step 110, the process involves blending the material inserted into the chamber to a desired consistency using the blade positioned within the chamber. This step is crucial for the functionality of the portable blending device, ensuring that the material achieves the required texture or smoothness as per the user's needs.

The entities involved in this step include the material, the chamber, and the blade. The material is the substance that the user wishes to blend, which is placed inside the chamber. The chamber is a designated space within the portable blending device that houses the material and the blade. The blade, positioned within the chamber, is the component responsible for the actual blending action.

The actions associated with these entities are as follows:
The material is inserted into the chamber.
The blade, positioned within the chamber, blends the material to a desired consistency.

The blade is configured to blend the material inserted into the chamber. The chamber is positioned within the portable blending device, and the blade is positioned along the lower portion of the chamber. The material is blended by the blade to a desired consistency.

The process begins with the user inserting the material into the chamber. Once the material is inside the chamber, the blade, which is strategically positioned along the lower portion of the chamber, is activated to blend the material. The blending action of the blade ensures that the material is processed to the desired consistency, which could range from a coarse blend to a fine puree, depending on the user's requirements.

The compact size of the portable blending device, with specific dimensions of approximately 1.2 inches in length, 1.2 inches in width, and 3.5 inches in height, makes it convenient for users to carry and use the device anywhere. The inclusion of a distribution port and a power button along the top portion of the portable blender further enhances its usability and portability.

In summary, step 110 involves the action of blending the material to a desired consistency using the blade positioned within the chamber. This step ensures that the portable blending device performs its primary function effectively, providing users with a convenient and efficient tool for blending various materials to their preferred texture.

While the present invention has been described above in terms of specific embodiments for purposes of illustration, it is to be understood that the invention is not limited to these disclosed embodiments. Likewise, while “the invention” or “present invention” may have been referred to at the times in this disclosure those terms are not intended to limit the scope of this disclosure or to suggest in any way that there is a single version or embodiment. While the invention relates generally to a portable blender, inventive concepts that fall within the scope of this disclosure may include a variety of optional features, which do not need to be present in every version or embodiment. Various modifications and changes can be made without departing from the spirit of the invention. In fact, modifications and other embodiments of the invention will also come to mind of those skilled in the art to which this invention pertains, and which are intended to be and are covered by both this disclosure and the appended claims. It is indeed intended that the scope should be determined by proper interpretation and construction of the appended claims and their legal equivalents, as understood by those skilled in the art relying upon the disclosure in this specification and the attached drawings.

The skilled person will be aware of a range of possible modifications of the various embodiments described above. Accordingly, the present invention is defined by the claims and their equivalents.

What is claimed is:

1. A portable blending device, comprising:
a chamber positioned within the portable blending device;
a shaft interconnected to a motor; wherein said shaft has an upper rectangular end;
a blade positioned within the chamber, wherein the blade is configured to blend material inserted into the chamber; wherein said blade has mounting aperture that allows insertion of said upper rectangular end of said shaft;
a port for distributing material;
a charging port positioned on the portable blending device;
a power control positioned on the portable blending device;
a power source included within the portable blending device; and
multiple attachment points positioned on the portable blending device,
wherein the portable blending device has a compact size with specific dimensions.

2. The portable blending device of claim 1, wherein the chamber is positioned along a lower portion of the portable blending device.

3. The portable blending device of claim 1, wherein the blade is positioned along a lower portion of the chamber.

4. The portable blending device of claim 1, wherein the charging port is a USB-C port.

5. The portable blending device of claim 4, wherein the USB-C port is positioned along a bottom portion of the portable blending device.

6. The portable blending device of claim 1, wherein the power control is a power button.

7. The portable blending device of claim 6, wherein the power button is positioned along a top portion of the portable blending device.

8. The portable blending device of claim 1, wherein the power source is a battery.

9. The portable blending device of claim 1, wherein the multiple attachment points comprise at least two attachment hooks.

10. The portable blending device of claim 9, wherein the at least two attachment hooks are positioned along one side of the portable blending device.

11. The portable blending device of claim 1, wherein the specific dimensions comprise:
a length of approximately 1.2 inches;
a width of approximately 1.2 inches; and
a height of approximately 3.5 inches.

12. A method of using a portable blending device, comprising:
inserting material into a chamber positioned within the portable blending device;
activating a power control positioned on the portable blending device to blend the material using a blade positioned within the chamber;
charging the portable blending device via a charging port positioned on the portable blending device; and
attaching the portable blending device to an external object using multiple attachment points positioned on the portable blending device,
wherein the portable blending device has a compact size with specific dimensions.

13. The method of claim 12, wherein inserting the material into the chamber comprises inserting the material into the chamber positioned along a lower portion of the portable blending device.

14. The method of claim 12, wherein activating the power control comprises pressing a power button positioned along a top portion of the portable blending device.

15. The method of claim 12, wherein charging the portable blending device comprises charging a battery included within the portable blending device.

16. The method of claim 12, wherein charging the portable blending device via the charging port comprises charging the portable blending device via a USB-C port positioned along a bottom portion of the portable blending device.

17. The method of claim 12, wherein attaching the portable blending device to the external object comprises attaching the portable blending device using at least two attachment hooks positioned along one side of the portable blending device.

18. The method of claim 12, wherein the specific dimensions of the portable blending device comprise:
a length of approximately 1.2 inches;
a width of approximately 1.2 inches; and
a height of approximately 3.5 inches.

19. The portable blending device of claim 1, wherein the material inserted into the chamber is blended by the blade to a desired consistency.

20. The method of claim 12, further comprising blending the material inserted into the chamber to a desired consistency using the blade positioned within the chamber.
